(19) United States
(12) Patent Application Publication
(10) Pub. No.: US 2023/0383084 A1
(43) Pub. Date: Nov. 30, 2023

(54) OPTIMUM COMPOSITION OF TPU PRODUCT FOR TIRES

(71) Applicant: BASF SE, Ludwigshafen am Rhein (DE)

(72) Inventors: Elmar POESELT, Lemfoerde (DE); Frank Thielbeer, Lemfoerde (DE); Lisa Marie Schmidt, Lemfoerde (DE); Theresa Huelsmann, Lemfoerde (DE); Peter Gutmann, Ludwigshafen am Rhein (DE); Uwe Keppeler, Ludwigshafen am Rhein (DE); Florian Tobias Rapp, Ludwigshafen am Rhein (DE); Eva Anna Haase, Lemfoerde (DE)

(73) Assignee: BASF SE, Ludwigshafen am Rhein (DE)

(21) Appl. No.: 18/245,156

(22) PCT Filed: Sep. 13, 2021
(86) PCT No.: PCT/EP2021/075077

§ 371 Date: Mar. 13, 2023

(30) Foreign Application Priority Data
Sep. 14, 2020 (EP) 20196004.4

(51) Int. Cl. C08J 9/232

(52) U.S. Cl. CPC C08J 9/232; C08J 2201/02; C08J 2375/04

(57) ABSTRACT

A molded body contains foamed pellets, containing a composition (M1) containing a thermoplastic elastomer (TPE-1), having a ratio of average surface area to average volume of the pellets (A/V) determined according to method-example 1 and 2 in a range of from 1.4 to 3.0. A process for preparing the molded body involves providing the foamed pellets comprising the composition (M1), and fusing the foamed pellets to obtain the molded body. A molded body obtained or obtainable by the process is useful in furniture, seating, cushioning, car wheels or parts of car wheels, toys, animal toys, tires or parts of a tire, saddles, balls and sports equipment, sports mats, or as floor covering or wall paneling, especially for sports surfaces, track and field surfaces, sports halls, children's playgrounds, and pathways.

The present invention is directed to a molded body comprising foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0. The present invention is also directed to a process for preparing a molded body providing foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0, and fusing the foamed pellets to obtain the molded body. The present invention is also directed to the molded body obtained or obtainable by said process as well as the use thereof in furniture, seating, as cushioning, car wheels or parts of car wheels, toys, animal toys, tires or parts of a tire, saddles, balls and sports equipment, for example sports mats, or as floor covering and wall paneling, especially for sports surfaces, track and field surfaces, sports halls, children's playgrounds and pathways.

Foams, especially particle foams, have long been known and have been widely described in the literature, e.g. in Ullmann's “Encyclopedia of Technical Chemistry”, 4th edition, volume 20, p. 416 ff.

Highly elastic, largely closed-cell foams, such as particle foams made of thermoplastic elastomers, which e.g. produced in an autoclave or by the extruder process show special dynamic properties and in some cases also good rebound resilience. Hybrid foams made from particles of thermoplastic elastomers and system foam or binders are also known. Depending on the foam density, the manufacturing method and the matrix material, a relatively broad level of rigidity can be adjusted. The properties of the foam can also be influenced by post-treatment of the foam, such as tempering.

Foamed pellets, which are also referred to as particle foams (or bead foams, particle foam), and molded articles made therefrom, based on thermoplastic polyurethane or other elastomers, are known (for example WO 94/20568A1, WO 2007/082838 A1, WO2017/030835 A1, WO 2013/153190 A1, WO2010/010010 A1) and can be used in many different ways.

A foamed pellet or also a particle foam or bead foam in the sense of the present invention refers to a foam in the form of a particle, the average length of the particles preferably being in the range of from 1 to 8 mm. In the case of non-spherical, e.g. elongated or cylindrical particles mean the longest dimension by length.

Various applications are known for foamed pellets and molded bodies prepared from the foamed pellets. For example WO 2019/185687 A1 discloses a non-pneumatic tire comprising polyurethane matrix and expanded thermoplastic elastomer particles, wherein said non-pneumatic tire comprising 60 to 90 wt % of a polyurethane matrix and 10 to 40 wt % of expanded thermoplastic elastomer particles. However, the tires often show insufficient comfort in comparison to pneumatic tires, have a higher rolling resistance in comparison to pneumatic tires and have a significant higher density as a semi-compact material.

The use of large foamed pellets, for example with a length of greater than 5 mm often results in inhomogeneous density distribution due to e.g. filling problems.

Also WO2017/039451 A1 and WO2018/004344 A1 are directed to non-pneumatic tires. Vehicle wheel assemblies are disclosed which comprise a wheel rim having two opposed circular rim flanges; an outer tire having two beads secured at the circular rim flanges; an inlay; a non-pneumatic inner tire comprising expanded thermoplastic polyurethane (E-TPU), which inner tire is enclosed by the outer tire, the inlay and the wheel rim. Also the tires disclosed in WO2017/039451 A1 and WO2018/004344 A1 show sufficient comfort in comparison to pneumatic tires but have a higher rolling resistance in comparison to pneumatic tires.

For some applications such as for example tires a sufficient tensile strength of the molded body prepared from the foamed pellets is advantageous for the stability in the preparation process and over the life time of the tires. Generally, to obtain a sufficient tensile strength, the material usually has to be steam chest molded with a higher amount of energy, i.e. higher temperature and longer duration. This usually results in a softer material with lower compression strength which is in particular disadvantageous for the use as tires resulting in a lower comfort feeling. For the application as tires, a suitable combination of tensile strength and compression of the materials is necessary.

It was therefore an object of the present invention to provide a process for preparing a molded body using foamed pellets which can be molded under mild conditions resulting in good compression strength at comparable tensile strength, and comparable density of the molded body.

According to the present invention, this object is solved by a molded body comprising foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0.

It was surprisingly found that a molded body comprising foamed pellets in the molded body having a ratio of the average surface area to the average volume of the pellets (A/V) determined according to method-example 1 and 2 in a range of from 1.4 to 3.0 and preferably an average diameter in the range of from 1 to 8 mm shows improved properties, such as compression strength, tensile strength and density.

The dimensions of the foamed pellets in the molded body are determined after the preparation process of the molded body, i.e. the dimensions might differ from those of the foamed pellets used for the preparation of the molded body.

According to a further embodiment, the present invention is also directed to a molded body as disclosed above, wherein the molded body comprises no foamed pellets having a ratio of the average surface area to the average volume of the pellets (A/V) determined according to method-example 1 and 2 outside the range of from 1.4 to 3.0.

According to a further embodiment, the present invention is also directed to a molded body as disclosed above, wherein the molded body consists of foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0.

According to a further aspect, the present invention is also directed to a process for preparing a molded body comprising the steps of
(i) providing foamed pellets comprising a composition (M1) comprising a thermoplastic elastomer (TPE-1) having a ratio of the average surface area to the average volume of the pellets (A/V) determined according to method-examples 1 and 2 in the range of from 1.4 to 3.0,
(ii) fusing the foamed pellets to obtain the molded body.

It was surprisingly found that by using foamed pellets having a ratio of the average surface area to the average volume of the pellets (A/V) determined according to method-example 1 and 2 in a range of from 1.4 to 3.0 and preferably an average diameter in the range of from 1 to 8 mm a molded body can be obtained using mild conditions for the fusing step which shows improved properties, in particular an improved combination of features such as compression strength, tensile strength and density.

According to a further aspect, the present invention is also directed to a molded body obtained or obtainable by a process comprising the steps of
(i) providing foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0,
(ii) fusing the foamed pellets to obtain the molded body.

It has been found that when foamed pellets comprising a composition (M1) comprising a thermoplastic elastomer (TPE-1) having a ratio of the average surface area to the average volume of the pellets (A/V) determined according to method-example 1 and 2 in the range of from 1.4 to 3.0 are used to prepare a molded body a reduced amount of energy (by e.g. reduction of steam pressure or rather reduction of steaming time)is needed for molding to achieve a specified tensile strength. The improved absorption of energy of the specific foamed pellets used according to the present invention allows to reduce the time needed for the fusing step which in turn results in a reduced loss of the mechanical properties of the foamed pellets and the molded body.

It can be advantageous to use foamed pellets having an average length in the range from 1 to 8 mm. It is even more advantageous if the average length in the range from 1 to 8 mm and the ratio of average length to average width is in a range of 1.0 to 2.0 It has been found that a more homogeneous distribution of the foamed pellets in a mold can be achieved and the resulting molded bodies show less variation in density as a result.

According to the present invention, the size parameters for one particle are determined as an image analysis of all available images of this specific particle. Length and width are determined by applying parallel tangents to the outer edge of the particle on the respective image. The length is defined as the largest, the width as the shortest possible distance between two parallel tangents according to method example 1.

According to a further embodiment, the present invention is directed to the process as disclosed above, wherein the average length of the foamed pellets is in the range of from 1 to 8 mm, preferably in the range of from 1 to 6, in particular in the range of from 2 to 6, more preferable in the range of from 3 to 5.

According to a further embodiment, the present invention is directed to the molded body as disclosed above, wherein the average length of the foamed pellets is in the range of from 1 to 8 mm.

According to a further embodiment, the present invention is directed to the process as disclosed above, wherein the ratio of the average length of the pellet to the average width of the pellet is in the range of from 1.0 to 2.0.

According to a further embodiment, the present invention is directed to the molded body as disclosed above, wherein the ratio of the average length of the pellet to the average width of the pellet is in the range of from 1.0 to 2.0.

Preferably, the ratio of the average length of the pellet to the average width of the pellet is in the range of from 1.0 to 1.7, more preferable in the range of from 1.0 to 1.3.

The shape of the pellets used in the process according to the present invention may vary. It is possible to use rounded, non-spherical, e.g. elongated or cylindrical particles as well as pellets with e.g. flatted surface spots.

The shape and dimensions of the foamed pellets in the molded body may differ from the shape and dimensions of the foamed pellets used in the process due to the process conditions. It is for example possible that rounded foamed pellets are used in the process and the foamed pellets in the molded body have a rounded, non-spherical shape, e.g. elongated or cylindrical pellets as well as pellets with e.g. flatted surface spots. The average length of the foamed pellets in the molded body may for example be in the range of from 1 to 8 mm. In the case of non-spherical, e.g. elongated or cylindrical particles mean the longest dimension by length.

According to the present invention, according to step (i) of the process, foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0 are provided. According to the present invention, it is possible to use a process for preparing the respective foamed pellets which result in the ratio according to the present invention to provide the respective foamed pellets. It is also possible to provide the respective particles by selecting foamed pellets with a suitable ratio of the average surface area to the average volume of the pellets (A/V), for example by sieving. It is also possible to use additional measures or combinations of the respective measures according to the present invention.

It has been found that advantageous properties of the molded bodies can be obtained when foamed pellets are used which have a ratio of the average surface area to the average volume of the pellets (A/V) determined according to method-example 1 and 2 in a range of from 1.4 to 3.0.

According to the present invention, the foamed pellets are fused according to step (ii). Fusing the foamed pellets is preferably carried out in a mold to shape the molded body obtained. In principle, all suitable methods for fusing foamed pellets can be used according to the present invention, for example fusing at elevated temperatures, such as for example steam chest molding, molding at high frequencies, for example using electromagnetic radiation, processes using a double belt press, or variotherm processes.

Processes for producing foamed pellets from thermoplastic elastomers are known per se to the person skilled in the art. If, according to the invention, a foamed granulate made of the thermoplastic elastomer (TPE-1) is used, the bulk density of the foamed granulate is, for example, in the range from 20 g/l to 300 g/l.

Preferably, the thermoplastic elastomer has a soft phase with a glass transition temperature T_{g} in the range of from <10° C. determined by dynamic mechanical thermal analysis determined by loss factor (tan δ) according to DIN EN ISO 6721-1-2011-08 at a heating rate of 2 K/min at a frequency of 1 Hz in torsion mode. Deviant from the DIN norm, the temperature was adjusted step wise by 5 K and 35 s per step which corresponds to a continuous heating rate of 2 K/min. The measurements were conducted with a sample with a ratio of width:thickness of 1:6. The sample was prepared by injection moulding followed by annealing of the material at 100° C. for h.

Therefore, according to a further embodiment, the present invention is also directed to the process as disclosed above, wherein the thermoplastic elastomer has a soft phase with a glass transition temperature T_{g} in the range of from <10° C. more preferable below −10° C., particularly preferred below −30° C. determined by dynamic mechanical thermal analysis determined by loss factor (tan δ) according to DIN EN ISO 6721-1-2011-08 at a heating rate of 2 K/min at a frequency of 1 Hz in torsion mode. Deviant from the DIN norm, the temperature was adjusted step wise by 5 K and 35 s per step which corresponds to a continuous heating rate of 2 K/min. The measurements were conducted with a sample with a ratio of width:thickness of 1:6. The sample was prepared by injection moulding followed by annealing of the material at 100° C. for 20 h. According to a further embodiment, the present invention is directed to the molded body as disclosed above, wherein the thermoplastic elastomer has a soft phase with a glass transition temperature T_{g} in the range of from <10° C. determined by dynamic mechanical thermal analysis determined by loss factor (tan δ) according to DIN EN ISO 6721-1-2011-08 at a heating rate of 2 K/min at a frequency of 1 Hz in torsion mode. Deviant from the DIN norm, the temperature was adjusted step wise by 5 K and 35 s per step which corresponds to a continuous heating rate of 2 K/min. The measurements were conducted with a sample with a ratio of width:thickness of 1:6. The sample was prepared by injection moulding followed by annealing of the material at 100° C. for 20 h.

Suitable thermoplastic elastomers for producing the foams or moldings according to the invention are known per se to the person skilled in the art. Suitable thermoplastic elastomers are described, for example, in “Handbook of Thermoplastic Elastomers”, 2nd edition June 2014. For example, the thermoplastic elastomer (TPE-1) can be a thermoplastic polyurethane (TPU), a thermoplastic polyether amide (TPA), a polyether ester (TPC), a polyester ester (TPC), a thermoplastic elastomer based on olefin (TPO), a crosslinked thermoplastic elastomer based on olefin or a thermoplastic vulcanizate (TPV) or a thermoplastic styrene butadiene block copolymer (TPS).

According to a further embodiment, the present invention is directed to the molded body as disclosed above, wherein the thermoplastic elastomer is selected from the group consisting of thermoplastic polyurethanes (TPU), thermoplastic polyamides (TPA) and thermoplastic polyetheresters (TPC), polyesteresters (TPC), thermoplastic vulcanizates (TPV), thermoplastic polyolefins (TPO), thermoplastic styrenic elastomers (TPS) and mixtures thereof.

Suitable production processes for these thermoplastic elastomers or foams or foamed granules from the thermoplastic elastomers mentioned are likewise known to the person skilled in the art.

Suitable thermoplastic polyether esters and polyester esters can be prepared by all the conventional processes known from the literature by transesterification or esterification of aromatic and aliphatic dicarboxylic acids having 4 to 20 carbon atoms or their esters with suitable aliphatic and aromatic diols and polyols (cf. “Polymer Chemistry”, Interscience Publ., New York, 1961, p. 111-127; Kunststoff Handbuch, Volume VIII, C. Hanser Verlag, Munich 1973 and Journal of Polymer Science, Part A1, 4, pages 1851-1859 (1966)).

Suitable aromatic dicarboxylic acids include e.g. Phthalic acid, iso- and terephthalic acid or their esters. Suitable aliphatic dicarboxylic acids include e.g. Cyclohexane-1,4-dicarboxylic acid, adipic acid, sebacic acid, azelaic acid and decanedicarboxylic acid as saturated dicarboxylic acids as well as maleic acid, fumaric acid, aconitic acid, itaconic acid, tetrahydrophthalic acid and tetrahydroterephthalic acid as unsaturated dicarboxylic acids.

Suitable diol components are, for example, diols of the general formula HO—(CH2) n-OH, with n=2 to 20, such as ethylene glycol, propanediol (1,3), butanediol (1,4) or hexanediol (1,6). Polyetherols of the general formula HO—(CH2)n-O— (CH2)m-OH, where n is equal to or different from m and n or m=2 to 20, unsaturated diols and polyetherols such as butenediol-(1,4); Diols and polyetherols containing aromatic units; as well as polyesterols.

In addition to the carboxylic acids or their esters mentioned and the alcohols mentioned, all other common representatives of these classes of compounds can be used to provide the polyether esters and polyester esters used according to the invention.

The thermoplastic polyetheramides can be obtained by the reaction of amines and carboxylic acids or their esters by all of the methods known from the literature. Amines and or carboxylic acid also contain ether units of the type R—O—R, where R=organic radical (aliphatic and/or aromatic). In general, monomers of the following classes of compounds are used: HOOC—R′—NH2, where R′ can be aromatic and aliphatic, preferably containing ether units of the type R—O—R, where R=organic radical (aliphatic and/or aromatic); aromatic dicarboxylic acids, e.g. Phthalic acid, isophthalic acid and terephthalic acid or their esters and aromatic dicarboxylic acids containing ether units of the type R—O—R, where R=organic radical (aliphatic and/or aromatic); aliphatic dicarboxylic acids, e.g. Cyclohexane-1,4-dicarboxylic acid, adipic acid, sebacic acid, azelaic acid and decanedicarboxylic acid as saturated dicarboxylic acids as well as maleic acid, fumaric acid, aconitic acid, itaconic acid, tetrahydrophthalic acid and tetrahydroterephthalic acid as unsaturated as well as aliphatic dicarboxylic acids R=containing organic units, R being ether units, ether units can be aliphatic and/or aromatic); Diamines of the general formula H2N—R″—NH2, where R″ is aromatic and aliphatic, preferably containing ether units of the type R—O—R, where R=organic radical (aliphatic and/or aromatic); Lactams such as £-caprolactam, pyrrolidone or laurolactam; as well as amino acids.

In addition to the carboxylic acids or their esters mentioned and the amines, lactams and amino acids mentioned, all other common representatives of these classes of compounds can be used to provide the polyetheramine used according to the invention.

The thermoplastic elastomers with block copolymer structure used according to the invention preferably contain vinylaromatic, butadiene and isoprene as well as polyolefin and vinyl units, for example ethylene, propylene & vinyl acetate units. Styrene-butadiene copolymers are preferred.

The thermoplastic elastomers with block copolymer structure, polyether amides, polyether esters and polyester esters used according to the invention are preferably selected such that their melting points are 300° C., preferably 250° C., in particular 220° C.

The thermoplastic elastomers with block copolymer structure, polyether amides, polyether esters and polyester esters used according to the invention can be partially crystalline or amorphous.

Suitable olefin-based thermoplastic elastomers (TPO) in particular have a hard segment and a soft segment, the hard segment being, for example, a polyolefin such as polypropylene and polyethylene and the soft segment being a rubber component such as ethylene-propylene rubber. Blends of a polyolefin and a rubber component, dynamically cross-linked types and polymerized types are suitable.

For example, structures are suitable in which an ethylene-propylene rubber (EPM) is dispersed in polypropylene; Structures in which a cross-linked or partially cross-linked ethylene-propylene-diene rubber (EPDM) is dispersed in polypropylene; statistical copolymers of ethylene and an α-olefin, such as propylene and butene; or block copolymers of a polyethylene block and an ethylene/α-olefin copolymer block. Suitable α-olefins are, for example, propylene, 1-butene, 1-pentene, 1-hexene, 1-heptene, 1-octene, 1-nonen, 1-n decene, 3-methyl-1-butene and 4-methyl-1-Pentene or mixtures of these olefins.

Suitable semicrystalline polyolefins are, for example, homopolymers of ethylene or propylene or copolymers containing monomeric ethylene and/or propylene units. Examples are copolymers of ethylene and propylene or an alpha olefin with 4-12 C atoms and copolymers of propylene and an alpha olefin with 4-12 C atoms. The concentration of ethylene or the propylene in the copolymers is preferably so high that the copolymer is semicrystalline.

In the case of statistical copolymers, for example, an ethylene content or a propylene content of about 70 mol % or more are suitable.

Suitable polypropylenes are propylene homopolymers or also polypropylene block copolymers, for example statistical copolymers of propylene and up to about 6 mol % of ethylene.

Suitable thermoplastic styrene block copolymers usually have polystyrene blocks and elastomeric blocks. Suitable styrene blocks are selected, for example, from polystyrene, substituted polystyrenes, poly (alpha-methylstyrenes), ring-halogenated styrenes and ring-alkylated styrenes. Suitable elastomeric blocks are, for example, polydiene blocks such as polybutadienes and polyisoprenes, poly (ethylene/butylene) copolymers and poly (ethylene/propylene) copolymers, polyisobutylenes, or also polypropylene sulfides or polydiethylsiloxanes

According to a further embodiment, the present invention is directed to the process as disclosed above, wherein the thermoplastic elastomer is selected from the group consisting of thermoplastic polyurethanes, thermoplastic polyamides and thermoplastic polyetheresters, polyesteresters and mixtures thereof.

According to a further embodiment, the present invention is directed to the process as disclosed above, wherein the thermoplastic elastomer is selected from the group consisting of thermoplastic polyurethanes.

Further suitable thermoplastic elastomers (TPE-1) are thermoplastic polyurethanes. Also thermoplastic polyurethanes are well known. They are produced by reaction of isocyanates with isocyanate-reactive compounds for example polyols with number-average molar mass from 500 g/mol to 100 00 g/mol and optionally chain extenders with molar mass from 50 g/mol to 499 g/mol, optionally in the presence of catalysts and/or conventional auxiliaries and/or additional substances.

For the purposes of the present invention, preference is given to thermoplastic polyurethanes obtainable via reaction of isocyanates with isocyanate-reactive compounds for example polyols with number-average molar mass from 500 g/mol to 10000 g/mol and a chain extender with molar mass from 50 g/mol to 499 g/mol, optionally in the presence of catalysts and/or conventional auxiliaries and/or additional substances.

The isocyanate, isocyanate-reactive compounds for example polyols and, if used, chain extenders are also, individually or together, termed structural components. The structural components together with the catalyst and/or the customary auxiliaries and/or additional substances are also termed starting materials.

The molar ratios of the quantities used of the polyol component can be varied in order to adjust hardness and melt index of the thermoplastic polyurethanes, where hardness and melt viscosity increase with increasing content of chain extender in the polyol component at constant molecular weight of the TPU, whereas melt index decreases.

For production of the thermoplastic polyurethanes, isocyanates and polyol component, where the polyol component in a preferred embodiment also comprises chain extenders, are reacted in the presence of a catalyst and optionally auxiliaries and/or additional substances in amounts such that the equivalence ratio of NCO groups of the diisocyanates to the entirety of the hydroxyl groups of the polyol component is in the range from 1:0.8 to 1:1.3.

Another variable that describes this ratio is the index. The index is defined via the ratio of all of the isocyanate groups used during the reaction to the isocyanate-reactive groups, i.e. in particular the reactive groups of the polyol component and the chain extender. If the index is 1000, there is one active hydrogen atom for each isocyanate group. At indices above 1000, there are more isocyanate groups than isocyanate-reactive groups.

An equivalence ratio of 1:0.8 here corresponds to an index of 1250 (index 1000=1:1), and a ratio of 1:1.3 corresponds to an index of 770.

In a preferred embodiment, the index in the reaction of the abovementioned components is in the range from 965 to 1110, preferably in the range from 970 to 1110, particularly preferably in the range from 980 to 1030, and also very particularly preferably in the range from 985 to 1010.

Preference is given in the invention to the production of thermoplastic polyurethanes where the weight-average molar mass (M_{w}) of the thermoplastic polyurethane is at least 60 000 g/mol, preferably at least 80 000 g/mol and in particular greater than 100 000 g/mol. The upper limit of the weight-average molar mass of the thermoplastic polyurethanes is very generally determined by processibility, and also by the desired property profile. The number-average molar mass of the thermoplastic polyurethanes is preferably from 80 000 to 300 000 g/mol. The average molar masses stated above for the thermoplastic polyurethane, and also for the isocyanates and polyols used, are the weight averages determined by means of gel permeation chromatography (e.g. in accordance with DIN 55672-1, March 2016).

Organic isocyanates that can be used are aliphatic, cycloaliphatic, araliphatic and/or aromatic isocyanates.

Aliphatic diisocyanates used are customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, methylenedicyclohexyl 4,4′-, 2,4′- and/or 2,2′-diisocyanate (H12MDI).

Suitable aromatic diisocyanates are in particular naphthylene 1,5-diisocyanate (NDI), tolylene 2,4- and/or 2,6-diisocyanate (TDI), 3,3′-dimethyl-4,4′-diisocyanatobiphenyl (TODD, p phenylene diisocyanate (PDI), diphenylethane 4,4′-diisoyanate (EDI), methylenediphenyl diisocyanate (MDI), where the term MDI means diphenylmethane 2,2′, 2,4′- and/or 4,4′-diisocyanate, 3,3′-dimethyldiphenyl diisocyanate, 1,2-diphenylethane diisocyanate and/or phenylene diisocyanate.

Mixtures can in principle also be used. Examples of mixtures are mixtures comprising at least a further methylenediphenyl diisocyanate alongside methylenediphenyl 4,4′-diisocyanate. The term “methylenediphenyl diisocyanate” here means diphenylmethane 2,2′-, 2,4′- and/or 4,4′-diisocyanate or a mixture of two or three isomers. It is therefore possible to use by way of example the following as further isocyanate: diphenylmethane 2,2′- or 2,4′-diisocyanate or a mixture of two or three isomers. In this embodiment, the polyisocyanate composition can also comprise other abovementioned polyisocyanates.

Other examples of mixtures are polyisocyanate compositions comprising 4,4′-MDI and 2,4′-MDI, or 4,4′-MDI and 3,3′-dimethyl-4,4′-diisocyanatobiphenyl (TODI) or 4,4′-MDI and H12MDI (4,4′-methylene dicyclohexyl diisocyanate) or 4,4′-M DI and TDI; or 4,4′-M DI and 1,5-naphthylene diisocyanate (NDI).

In accordance with the invention, three or more isocyanates may also be used. The polyisocyanate composition commonly comprises 4,4′-MDI in an amount of from 2 to 50%, based on the entire polyisocyanate composition, and the further isocyanate in an amount of from 3 to 20%, based on the entire polyisocyanate composition.

Crosslinkers can be used as well, moreover, examples being the aforesaid higher-functionality polyisocyanates or polyols or else other higher-functionality molecules having a plurality of isocyanate-reactive functional groups. It is also possible within the realm of the present invention for the products to be crosslinked by an excess of the isocyanate groups used, in relation to the hydroxyl groups. Examples of higher-functionality isocyanates are triisocyanates, e.g. triphenylmethane 4,4′,4″-triisocyanate, and also isocyanurates, and also the cyanurates of the aforementioned diisocyanates, and the oligomers obtainable by partial reaction of diisocyanates with water, for example the biurets of the aforementioned diisocyanates, and also oligomers obtainable by controlled reaction of semiblocked diisocyanates with polyols having an average of more than two and preferably three or more hydroxyl groups.

The amount of crosslinkers here, i.e. of higher-functionality isocyanates and higher-functionality polyols, ought not to exceed 3% by weight, preferably 1% by weight, based on the overall mixture of components.

The polyisocyanate composition may also comprise one or more solvents. Suitable solvents are known to those skilled in the art. Suitable examples are nonreactive solvents such as ethyl acetate, methyl ethyl ketone and hydrocarbons.

Isocyanate-reactive compounds are those with molar mass Mₙ that is preferably from 500 g/mol to 10000 g/mol, more preferably from 500 g/mol to 5000 g/mol, in particular from 500 g/mol to 3000 g/mol.

The statistical average number of hydrogen atoms exhibiting Zerewitinoff activity in the isocyanate-reactive compound is at least 1.8 and at most 2.2, preferably 2; this number is also termed the functionality of the isocyanate-reactive compound (b), and states the quantity of isocyanate-reactive groups in the molecule, calculated theoretically for a single molecule, based on a molar quantity. The isocyanate-reactive compound preferably is substantially linear and is one isocyanate-reactive substance or a mixture of various substances, where the mixture then meets the stated requirement.

The ratio of polyols and chain extender used is varied in a manner that gives the desired hard-segment content, which can be calculated by the formula disclosed in PCT/EP2017/079049. A suitable hard segment content here is below 60%, preferably below 40%, particularly preferably 25%.

The isocyanate-reactive compound preferably has a reactive group selected from the hydroxyl group, the amino groups, the mercapto group and the carboxylic acid group. Preference is given here to the hydroxyl group and very particular preference is given here to primary hydroxyl groups. It is particularly preferable that the isocyanate-reactive compound (b) is selected from the group of polyesterols, polyetherols and polycarbonatediols, these also being covered by the term “polyols”.

Suitable polymers in the invention are homopolymers, for example polyetherols, polyesterols, polycarbonatediols, polycarbonates, polysiloxanediols, polybutadienediols, and also block co-polymers, and also hybrid polyols, e.g. poly(ester/amide). Preferred polyetherols in the invention are polyethylene glycols, polypropylene glycols, polytetramethylene glycol (PTHF), polytrimethylene glycol. Preferred polyester polyols are polyadipates, polysuccinic esters and polycaprolactones.

In another embodiment, the present invention also provides a thermoplastic polyurethane as described above where the polyol composition comprises a polyol selected from the group consisting of polyetherols, polyesterols, polycaprolactones and polycarbonates.

Examples of suitable block copolymers are those having ether and ester blocks, for example polycaprolactone having polyethylene oxide or polypropylene oxide end blocks, and also polyethers having polycaprolactone end blocks. Preferred polyetherols in the invention are polyethylene glycols, polypropylene glycols, polytetramethylene glycol (PTHF) and polytrimethylene glycol. Preference is further given to polycaprolactone.

In a particularly preferred embodiment, the molar mass Mn of the polyol used is in the range from 500 g/mol to 10000 g/mol, preferably in the range from 500 g/mol to 5000 g/mol, in particular from 500 g/mol to 3000 g/mol.

Another embodiment of the present invention accordingly provides a thermoplastic polyurethane as described above where the molar mass Mn of at least one polyol comprised in the polyol composition is in the range from 500 g/mol to 10000 g/mol.

It is also possible in the invention to use mixtures of various polyols.

An embodiment of the present invention uses, for the production of the thermoplastic polyurethane, at least one polyol composition comprising at least polytetrahydrofuran. The polyol composition in the invention can also comprise other polyols alongside polytetrahydrofuran.

Materials suitable by way of example as other polyols in the invention are polyethers, and also polyesters, block copolymers, and also hybrid polyols, e.g. poly(ester/amide). Examples of suitable block copolymers are those having ether and ester blocks, for example polycaprolactone having polyethylene oxide or polypropylene oxide end blocks, and also polyethers having polycaprolactone end blocks. Preferred polyetherols in the invention are polyethylene glycols and polypropylene glycols. Preference is further given to polycaprolactone as other polyol.

Examples of suitable polyols are polyetherols such as polytrimethylene oxide and polytetramethylene oxide.

Another embodiment of the present invention accordingly provides a thermoplastic polyurethane as described above where the polyol composition comprises at least one polytetrahydrofuran and at least one other polyol selected from the group consisting of another polytetramethylene oxide (PTHF), polyethylene glycol, polypropylene glycol and polycaprolactone.

In a particularly preferred embodiment, the number-average molar mass Mn of the polytetrahydrofuran is in the range from 500 g/mol to 5000 g/mol, more preferably in the range from 550 to 2500 g/mol, particularly preferably in the range from 650 to 2000 g/mol and very preferably in the range from 650 to 1400 g/mol.

The composition of the polyol composition can vary widely for the purposes of the present invention. By way of example, the content of the first polyol, preferably of polytetrahydrofuran, can be in the range from 15% to 85%, preferably in the range from 20% to 80%, more preferably in the range from 25% to 75%.

The polyol composition in the invention can also comprise a solvent. Suitable solvents are known per se to the person skilled in the art.

Insofar as polytetrahydrofuran is used, the number-average molar mass Mn of the polytetrahydrofuran is by way of example in the range from 500 g/mol to 5000 g/mol, preferably in the range from 550 to 2500 g/mol, particular preferably in the range from 650 to 2000 g/mol. It is further preferable that the number-average molar mass Mn of the polytetrahydrofuran is in the range from 650 to 1400 g/mol.

The number-average molar mass Mn here can be determined as mentioned above by way of gel permeation chromatography.

Another embodiment of the present invention also provides a thermoplastic polyurethane as described above where the polyol composition comprises a polyol selected from the group consisting of polytetrahydrofurans with number-average molar mass Mn in the range from 500 g/mol to 5000 g/mol preferably in the range from 550 to 2500 g/mol, particular preferably in the range from 650 to 2000 g/mol. It is further preferable that the number-average molar mass Mn of the polytetrahydrofuran is in the range from 650 to 1400 g/mol.

It is also possible in the invention to use mixtures of various polytetrahydrofurans, i.e. mixtures of polytetrahydrofurans with various molar masses.

Chain extenders used are preferably aliphatic, araliphatic, aromatic and/or cycloaliphatic compounds with a molar mass from 50 g/mol to 499 g/mol, preferably having 2 isocyanate-reactive groups, also termed functional groups. Preferred chain extenders are diamines and/or alkanediols, more preferably alkanediols having from 2 to 10 carbon atoms, preferably having from 3 to 8 carbon atoms in the alkylene moiety, these more preferably having exclusively primary hydroxy groups.

Preferred embodiments use chain extenders, these being preferably aliphatic, araliphatic, aromatic and/or cycloaliphatic compounds with molar mass from 50 g/mol to 499 g/mol, preferably having 2 isocyanate-reactive groups, also termed functional groups. It is preferable that the chain extender is at least one chain extender selected from the group consisting of ethylene 1,2-glycol, propane-1,2-diol, propane-1,3-diol, butane-1,4-diol, butane-2,3-diol, pentane-1,5-diol, hexane-1,6-diol, diethylene glycol, dipropylene glycol, cyclohexane-1,4-diol, cyclohexane-1,4-dimethanol, neopentyl glycol and hydroquinone bis(beta-hydroxyethyl) ether (HQEE). Particularly suitable chain extenders are those selected from the group consisting of 1,2-ethanediol, propane-1,3-diol, butane-1,4-diol and hexane-1,6-diol, and also mixtures of the abovementioned chain extenders. Examples of specific chain extenders and mixtures are disclosed inter alia in PCT/EP2017/079049.

In preferred embodiments, catalysts are used with the structural components. These are in particular catalysts which accelerate the reaction between the NCO groups of the isocyanates and the hydroxyl groups of the isocyanate-reactive compound and, if used, the chain extender.

Examples of catalysts that are further suitable are organometallic compounds selected from the group consisting of organyl compounds of tin, of titanium, of zirconium, of hafnium, of bismuth, of zinc, of aluminum and of iron, examples being organyl compounds of tin, preferably dialkyltin compounds such as dimethyltin or diethyltin, or tin-organyl compounds of aliphatic carboxylic acids, preferably tin diacetate, tin dilaurate, dibutyltin diacetate, dibutyltin dilaurate, bismuth compounds, for example alkylbismuth compounds or the like, or iron compounds, preferably iron(III) acetylacetonate, or the metal salts of carboxylic acids, e.g. tin(II) isooctanoate, tin dioctanoate, titanic esters or bismuth(III) neodecanoate. Particularly preferred catalysts are tin dioctanoate, bismuth decanoate and titanic esters. Quantities preferably used of the catalyst are from 0.0001 to 0.1 part by weight per 100 parts by weight of the isocyanate-reactive compound. Other compounds that can be added, alongside catalysts, to the structural components are conventional auxiliaries. Mention may be made by way of example of surface-active substances, fillers, flame retardants, nucleating agents, oxidation stabilizers, lubricating and demolded body aids, dyes and pigments, and optionally stabilizers, preferably with respect to hydrolysis, light, heat or discoloration, inorganic and/or organic fillers, reinforcing agents and/or plasticizers.

Suitable dyes and pigments are listed at a later stage below.

Stabilizers for the purposes of the present invention are additives which protect a plastic or a plastics mixture from damaging environmental effects. Examples are primary and secondary antioxidants, sterically hindered phenols, hindered amine light stabilizers, UV absorbers, hydrolysis stabilizers, quenchers and flame retardants. Examples of commercially available stabilizers are found in Plastics Additives Handbook, 5th edn., H. Zweifel, ed., Hanser Publishers, Munich, 2001 ([1]), pp. 98-136.

The thermoplastic polyurethanes may be produced batchwise or continuously by the known processes, for example using reactive extruders or the belt method by the “one-shot” method or the prepolymer process, preferably by the “one-shot” method. In the “one-shot” method, the components to be reacted, and in preferred embodiments also the chain extender in the polyol component, and also catalyst and/or additives, are mixed with one another consecutively or simultaneously, with immediate onset of the polymerization reaction. The TPU can then be directly pelletized or converted by extrusion to lenticular pellets. In this step, it is possible to achieve concomitant incorporation of other adjuvants or other polymers.

In the extruder process, structural components, and in preferred embodiments also the chain extender, catalyst and/or additives, are introduced into the extruder individually or in the form of mixture and reacted, preferably at temperatures of from 100° C. to 280° C., preferably from 140° C. to 250° C. The resultant polyurethane is extruded, cooled and pelletized, or directly pelletized by way of an underwater pelletizer in the form of lenticular pellets.

In a preferred process, a thermoplastic polyurethane is produced from structural components isocyanate, isocyanate-reactive compound including chain extender, and in preferred embodiments the other raw materials in a first step, and the additional substances or auxiliaries are incorporated in a second extrusion step.

It is preferable to use a twin-screw extruder, because twin-screw extruders operate in force-conveying mode and thus permit greater precision of adjustment of temperature and quantitative output in the extruder. Production and expansion of a TPU can moreover be achieved in a reactive extruder in a single step or by way of a tandem extruder by methods known to the person skilled in the art.

According to the present invention, composition (M1) comprises the thermoplastic elastomer (TPE-1). The composition may comprise further components such as further thermoplastic elastomers or fillers. In the context of the present invention, the term fillers encompasses organic and inorganic fillers such as for example further polymers.

The composition (M1) may comprise the thermoplastic elastomer (TPE-1) in an amount in the range of from 85 to 100 wt.-% based on the weight of the composition (M1).

Unless otherwise noted, the amounts of the components of the composition (M1) add up to 100 wt.-%.

According to a further embodiment, the present invention is directed to the molded body as disclosed above, wherein composition (M1) comprises a filler in an amount in the range of from 0.1 to 20 wt.-% based on weight of the composition (M1).

According to a further embodiment, the present invention is directed to the process as disclosed above, wherein the composition (M1) comprises a filler in an amount in the range of from 0.1 to 15 wt.-% based on the weight of the composition (M1).

The filler may for example be selected from the group consisting of organic fillers such as polystyrene, polyethylene, polypropylene, polyethylene terephthalate, polycarbonates, polyamides, polybutylene terephthalate, polyethylene terephthalates and polylactic acids.

Inorganic fillers such as talcum, chalk, carbon black also can be used in the context of the present invention. Suitable fillers for thermoplastic elastomers are in principle known to the person skilled in the art.

According to a further embodiment, the composition (M1) may for example comprise styrene polymers such as atactic, syndiotactic or isotactic polystyrene, more preferably atactic polystyrene.

Atactic polystyrene of the invention, which is amorphous, has a glass transition temperature in the range of 100° C.±20° C. (determined according to DIN EN ISO 11357-1, February 2017/DIN EN ISO 11357-2, July 2014, Inflection point method). Syndiotactic and isotactic polystyrene of the invention are each semicrystalline and have a melting point in the region respectively of 270° C. and 240° C. (DIN EN ISO 11357-1, February 2017/DIN EN ISO 11357-3, April 2013, peak melting temperature).

The polystyrenes used have a modulus of elasticity in tension of more than 2500 M Pa (DIN EN ISO 527-1/2, June 2012).

The production and processing of the polystyrenes of the invention is described extensively in the literature, for example in Kunststoff-Handbuch Band 4, “Polystyrol” [Plastics handbook, vol. 4, “Polystyrene”], by Becker/Braun (1996).

Commercially available materials can also be used, for example PS 158 K (Ineos), PS 148 H Q (Ineos), STYROLUTION PS 156 F, STYROLUTION PS 158N/L, STYROLUTION PS 168N/L, STYROLUTION PS 153F, SABIC PS 125, SABIC PS 155, SABIC PS 160.

The composition (M1) may also comprise styrene with a modulus of elasticity below 2700 M Pa (DIN EN ISO 527-1/2, June 2012), such as styrene polymers selected from the group of the thermoplastic elastomers based on styrene, and of the high-impact polystyrenes (HIPS) which by way of example include SEBS, SBS, SEPS, SEPS-V and acrylonitrile-butadiene-styrene copolymers (ABS), very particular preference being given here to high-impact polystyrene (HIPS).

Commercially available materials can be used here, for example Styron A-TECH 1175, Styron A-TECH 1200, Styron A-TECH 1210, Styrolution PS 495S, Styrolution PS 485N, Styrolution PS 486N, Styrolution PS 542N, Styrolution PS 454N, Styrolution PS 416N, Michling PS HI, SABIC PS 325, SABIC PS 330.

It was surprisingly found that the use of fillers further reduces the required energy needed for moulding to achieve a specified tensile strength, and reduced energy advantageously leads to higher compression strength of the molded body obtained.

The materials obtained have a lower melting point compared to the respective materials without filler which is advantageous for the preparation process.

It was found in the context of the present invention, that the storage (G′) modulus of the composition (M1), in particular of the thermoplastic elastomer (TPE-1) used, also has an influence on the properties of the molded body obtained. It was found that it is particularly advantageous to adjust the G′ modulus at room temperature in the range of from 10 to 90 MPa.

According to a further embodiment, the present invention is directed to the process as disclosed above, wherein the composition (M1) has a G′ modulus of the compact material at room temperature in the range of from 10 to 90 MPa determined using DMA of a tempered body (20 h/100° C.) according to DIN EN ISO 6721-1-7:2018-03 with a heating program of 2 K/min at a frequency of 1 Hz.

According to a further embodiment, the present invention is directed to the molded body as disclosed above, wherein the composition (M1) has a G′ modulus of the compact material at room temperature in the range of from 10 to 90 M Pa determined using DMA of a tempered body (20 h/100° C.) according to DIN EN ISO 6721-1-7:2018-03 with a heating program of 2 K/min at a frequency of 1 Hz.

The process of the present invention comprises steps (i) and (ii). The process may comprise further steps such as for example temperature treatments or a treatment of the foamed pellets.

According to step (i), the foamed pellets are provided, preferably in a suitable mold, and then fused according to step (ii). Preferably, fusing is carried out by thermal fusing of the foamed pellets. According to a further embodiment, the present invention is directed to the process as disclosed above, wherein step (ii) is carried out by thermal fusing.

According to a further aspect, the present invention is also directed to a molded body obtained or obtainable according to a process as disclosed above.

The molded body according to the present invention can be used for a variety of applications, such as in furniture, seating, as cushioning, car wheels or parts of car wheels, toys, animal toys, as tires or parts of a tire, saddles, balls and sports equipment, for example sports mats, or as floor covering and wall paneling, especially for sports surfaces, track and field surfaces, sports halls, children's playgrounds and pathways.

According to a further aspect, the present invention is thus also directed to the use of a molded body obtained or obtainable according to a process as disclosed above or the molded body as disclosed above in furniture, seating, as cushioning, car wheels or parts of car wheels, toys, animal toys, as tires or parts of a tire, saddles, balls and sports equipment, for example sports mats, or as floor covering and wall paneling, especially for sports surfaces, track and field surfaces, sports halls, children's playgrounds and pathways.

The present invention is further illustrated by the following set of embodiments and combinations of embodiments resulting from the dependencies and back-references as indicated. In particular, it is noted that in each instance where a range of embodiments is mentioned, for example in the context of a term such as “The . . . of any one of embodiments 1 to 4”, every embodiment in this range is meant to be explicitly disclosed for the skilled person, i.e. the wording of this term is to be understood by the skilled person as being synonymous to “The . . . of any one of embodiments 1, 2, 3, and 4”. Further, it is explicitly noted that the following set of embodiments is not the set of claims determining the extent of protection, but represents a suitably structured part of the description directed to general and preferred aspects of the present invention.

A molded body comprising foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0.

A further preferred embodiment (2) concretizing embodiment (1) relates to said molded body, wherein the average length of the foamed pellets is in the range of from 1 to 8 mm.

A further preferred embodiment (3) concretizing any one of embodiments (1) or (2) relates to said molded body, wherein the ratio of the average length of the pellet to the average width of the pellet is in the range of from 1.0 to 2.0.

A further preferred embodiment (4) concretizing any one of embodiments (1) to (3) relates to said molded body, wherein the thermoplastic elastomer has a soft phase with a glass transition temperature T_{g} in the range of from <10° C. determined by dynamic mechanical thermal analysis determined by loss factor (tan δ) according to DIN EN ISO 6721-2011-08 at a heating rate of 2 K/min at a frequency of 1 Hz.

A further preferred embodiment (5) concretizing any one of embodiments (1) to (4) relates to said molded body, wherein the composition (M1) has a G′ modulus of the compact material at room temperature in the range of from 10 to 90 M Pa determined using DMA of a tempered body (20 h/100° C.) according to DIN EN ISO 6721-1-7:2018-03 with a heating rate of 2 K/min at a frequency of 1 Hz.

A further preferred embodiment (6) concretizing any one of embodiments (1) to (5) relates to said molded body, wherein the thermoplastic elastomer is selected from the group consisting of thermoplastic polyurethanes (TPU), thermoplastic polyamides (TPA) and thermoplastic polyetheresters (TPC), polyesteresters (TPC), thermoplastic vulcanizates (TPV), thermoplastic polyolefins (TPO), thermoplastic styrenic elastomers (TPS) and mixtures thereof.

A further preferred embodiment (7) concretizing any one of embodiments (1) to (6) relates to said molded body, wherein composition (M1) comprises a filler in an amount in the range of from 0.1 to 20 wt.-% based on weight of the composition (M1).

A further preferred embodiment (8) concretizing any one of embodiments (1) to (7) relates to said molded body, wherein the molded body consists of foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0.

A further embodiment (9) of the present invention relates to a process for preparing a molded body comprising the steps of
(i) providing foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0,
(ii) fusing the foamed pellets to obtain the molded body.

A further preferred embodiment (10) concretizing embodiment (9) relates to said process, wherein the average length of the foamed pellets is in the range of from 1 to 8 mm.

A further preferred embodiment (11) concretizing any one of embodiments (9) or (10) relates to said process, wherein the ratio of the average length of the pellet to the average width of the pellet is in the range of from 1.0 to 2.0.

A further preferred embodiment (12) concretizing any one of embodiments (9) to (11) relates to said process, wherein the thermoplastic elastomer has a soft phase with a glass transition temperature T_{g} in the range of from <10° C. determined by loss factor (tan δ) according to DIN at a heating rate of at a frequency of 1 Hz

A further preferred embodiment (13) concretizing any one of embodiments (9) to (12) relates to said process, wherein the composition (M1) has a G′ modulus of the compact material at room temperature in the range of from 10 to 90 M Pa determined using DMA of a tempered body (20 h/100° C.) according to DIN EN ISO 6721-1-7:2018-03 with a. heating rate of 2 K/min at a frequency of 1 Hz.

A further preferred embodiment (14) concretizing any one of embodiments (9) to (13) relates to said process, wherein the thermoplastic elastomer is selected from the group consisting of thermoplastic polyurethanes (TPU), thermoplastic polyamides (TPA) and thermoplastic polyetheresters (TPC), polyesteresters (TPC), thermoplastic vulcanizates (TPV), thermoplastic polyolefins (TPO), thermoplastic styrenic elastomers (TPS) and mixtures thereof.

A further preferred embodiment (15) concretizing any one of embodiments (9) to (14) relates to said process, wherein the thermoplastic elastomer is selected from the group consisting of thermoplastic polyurethanes, thermoplastic polyamides and thermoplastic polyetheresters, polyesteresters and mixtures thereof.

A further preferred embodiment (16) concretizing any one of embodiments (9) to (15) relates to said process, wherein the thermoplastic elastomer is selected from the group consisting of thermoplastic polyurethanes.

A further preferred embodiment (17) concretizing any one of embodiments (9) to (16) relates to said process, wherein composition (M1) comprises a filler in an amount in the range of from 0.1 to 20 wt.-% based on weight of the composition (M1).

A further preferred embodiment (18) concretizing any one of embodiments (9) to (17) relates to said process, wherein step (ii) is carried out by thermal fusing.

According to a further embodiment (19), the present invention relates to a molded body obtained or obtainable by a process according to any of embodiments (9) to (18).

According to a further embodiment (20), the present invention relates to a molded body obtained or obtainable by a process comprising the steps of
(i) providing foamed pellets comprising a composition (M1) comprising a thermoplastic elastomer (TPE-1) having a ratio of the average surface area to the average volume of the pellets (A/V) determined according to method-example 1 and 2 in a range of from 1.4 to 3.0,
(ii) fusing the foamed pellets to obtain the molded body.

A further preferred embodiment (21) concretizing embodiment (20) relates to said molded body, wherein the average length of the foamed pellets is in the range of from 1 to 8 mm.

A further preferred embodiment (22) concretizing any one of embodiments (20) or (21) relates to said molded body, wherein the ratio of the average length of the pellet to the average width of the pellet is in the range of from 1.0 to 2.0.

A further preferred embodiment (23) concretizing any one of embodiments (20) to (22) relates to said molded body, wherein the thermoplastic elastomer has a soft phase with a glass transition temperature T_{g} in the range of from <10° C. determined by loss factor (tan δ) according to DIN at a heating rate of at a frequency of 1 Hz

A further preferred embodiment (24) concretizing any one of embodiments (20) to (23) relates to said molded body, wherein the composition (M1) has a G′ modulus of the compact material at room temperature in the range of from 10 to 90 M Pa determined using DMA of a tempered body (20 h/100° C.) according to DIN EN ISO 6721-1-7:2018-03 with a heating rate of 2 K/min at a frequency of 1 Hz.

A further preferred embodiment (25) concretizing any one of embodiments (20) to (24) relates to said molded body, wherein the thermoplastic elastomer is selected from the group consisting of thermoplastic polyurethanes (TPU), thermoplastic polyamides (TPA) and thermoplastic polyetheresters (TPC), polyesteresters (TPC), thermoplastic vulcanizates (TPV), thermoplastic polyolefins (TPO), thermoplastic styrenic elastomers (TPS) and mixtures thereof.

A further preferred embodiment (26) concretizing any one of embodiments (20) to (25) relates to said molded body, wherein the thermoplastic elastomer is selected from the group consisting of thermoplastic polyurethanes, thermoplastic polyamides and thermoplastic polyetheresters, polyesteresters and mixtures thereof.

A further preferred embodiment (27) concretizing any one of embodiments (20) to (26) relates to said molded body, wherein the thermoplastic elastomer is selected from the group consisting of thermoplastic polyurethanes.

A further preferred embodiment (28) concretizing any one of embodiments (20) to (27) relates to said molded body, wherein composition (M1) comprises a filler in an amount in the range of from 0.1 to 20 wt.-% based on weight of the composition (M1).

A further preferred embodiment (29) concretizing any one of embodiments (20) to (28) relates to said molded body, wherein step (ii) is carried out by thermal fusing.

A further embodiment of the present invention is directed to the use of a molded body obtained or obtainable according to a process according to any one of embodiments (9) to (18) or the molded body of any of embodiments (1) to (8) or embodiment (19) to (29) in furniture, seating, as cushioning, car wheels or parts of car wheels, toys, animal toys, as tires or parts of a tire, saddles, balls and sports equipment, for example sports mats, or as floor covering and wall paneling, especially for sports surfaces, track and field surfaces, sports halls, children's playgrounds and pathways.

### BRIEF DESCRIPTION OF THE FIGURES

FIG. 1: gives a schematic overview over the measurement principle of the PartAn 3D.

FIG. 2: depicts a schematic particle showing the definition of the width (a) and length (b) of one particle

FIG. 3: depicts a schematic view of a spheroid, i.e. an ellipsoids with two equal semidiameters.

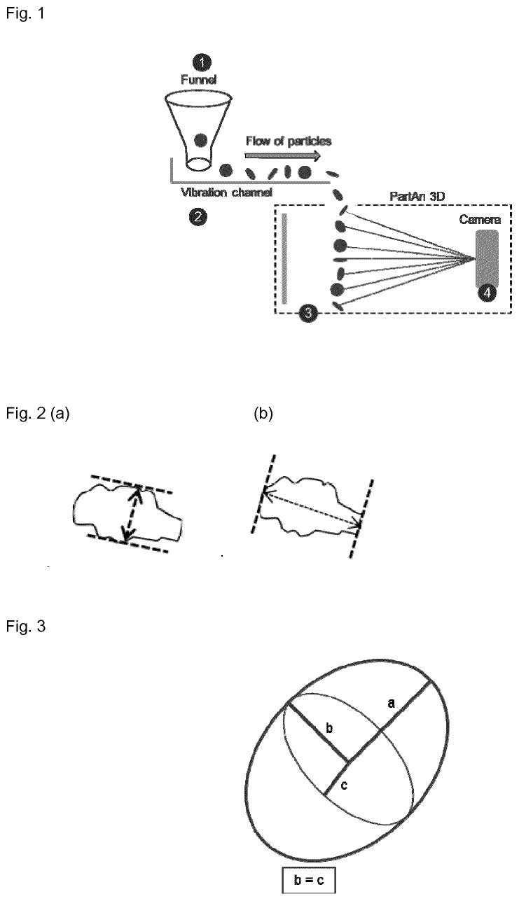

The present invention is further illustrated by the following reference examples, comparative examples, and examples.

### EXAMPLES

I. Preparation

1. TPU Synthesis
The synthesis of the TPU precursor was carried out using a 48D (12 zones) twin-screw-extruder (ZSK58 MC, co. Coperion). The temperature of the extruder housing/zones was between 150 to 230° C. and a screw-speed of 180 to 240 1/min at a through-put of 180 220 kg/h. In the first zone the polyol, chain extender, catalyst and diisocyanate was added. Further additives were added in zone 8. The formulation is listed in table 1.
After a gear pump and a melt filter the polymer melt at 180-210° C. was granulated using an underwater granulation. The granulate was subsequently dried using a heating fluidized bed (40-90° C.).

TABLE 1
Formulation of the used precursor.

| Ingredients | TPU 1 |
|---|---|
| Polyether based polyol having an OH-number of 112.2 and | 1000 |
| primary OH groups (based on tetramethylene oxide, | |
| functionality: 2) [parts] | |
| aromatic Isocyanate (4,4′-methylene diphenyl | 500 |
| diisocyanate) [parts] | |
| 1,4-butanediol [parts] | 89.9 |
| Stabilizer [parts] | 25 |
| Tin II isooctoate (50% in dioctyl adipate) [parts] | 50 ppm |

2. eTPU Preparation
The manufacturing of E-TPU was carried out on a twin screw extruder (Berstorff ZE 40) having a screw diameter of 44 mm and a L/D of 48, followed by a melt pump, a starting valve with screen changer, a die plate and an underwater pelletizer. The TPU was predried according to the processing guide at 80° C. for 3 hours for a residual humidity lower than 0.02 wt. %. For the materials, a Polystyrene resin (PS) was used. The content in wt. % of the total throughput was adapted according to table 2.
The materials (TPU 1 and PS) were dosed separately by gravimetric dosing units into the main feed of the twin screw extruder. Furthermore, beside these components a further thermoplastic polyurethane (Modified TPU) was dosed at 0.6 wt. % into the extruder. This modified TPU consists of a TPU which is compounded in a separate extrusion process with 4,4′-Diphenylmethandiisocianate with an average functionality of 2.05.
After the dosing, the material was molten and mixed in the extruder and afterwards a mixture of CO 2 and N₂ was added as blowing agents. In the remaining extruder barrels, the polymer and the blowing agents were mixed into a homogenous mixture. The mixture is pressed by a melt pump to a starting valve including screen changer and finally through a die plate into the water box of an underwater pelletizing system. There the mixture is cut to granulates, and foamed in the pressurized, tempered water system. The water flow transports the beads to a centrifuge dryer where they are separated from the water stream. The total throughput was set to 40 kg/h (including polymers, blowing agents).
In the following table 2, the individual settings and material compositions can be seen.

TABLE 2
Temperature profile of machine parts

| | | | | Temperature | Temperature | Pressure | Temperature |
|---|---|---|---|---|---|---|---|
| | | GPPS | Temperature | staring | die | underwater | underwater |
| eTPU | TPU | content | extruder | valve | plate | pelletizer | pelletizer |
| pellets | used | (wt. %) | (° C.) | (° C.) | (° C.) | (bar) | (° C.) |
| Ex. 1 | TPU 1 | 7.5 | 170-220 | 175 | 220 | 15 | 55 |
| Ex. 2 | TPU 1 | 12.5 | 190-220 | 185 | 220 | 15 | 55 |
| Comp. | TPU 1 | 7.5 | 170-220 | 155 | 220 | 15 | 40 |
| ex. 1 | | | | | | | |
| Comp. | TPU 1 | 12.5 | 170-220 | 155 | 220 | 15 | 40 |
| ex. 2 | | | | | | | |

The blowing agent compositions of CO₂ and N₂ that were used are listed in the following table 3. The amounts of the blowing agents are calculated on the total throughput of polymers.

TABLE 3
Blowing agent compositions for foaming

| eTPU pellets | CO2 [Gew. %] | N2 [Gew. %] |
|---|---|---|
| Example 1 | 2.3 | 0.1 |
| Example 2 | 2.3 | 0.1 |
| Comp. exa. 1 | 2.15 | 0.1 |
| Comp. exa. 2 | 2.3 | 0.1 |

The resulting bulk density of the expanded beads can be found in table 4.

TABLE 4
Resulting Bulk Density

| eTPU pellets | Bulk density (g/l) |
|---|---|
| Example 1 | 124 ± 6 |
| Example 2 | 119 ± 5 |
| Comp. exa. 1 | 122 ± 6 |
| Comp. exa. 2 | 128 ± 7 |

The E-TPU's used as examples and comparative examples are characterized in table 5. The average length and the average surface area to average volume ration are determined as explained in method example 1 and 2.

TABLE 4
Average Length and Average surface area/average volume ration
of the E-TPU's used as examples and comparative examples

| | Particle | | Average surface |
|---|---|---|---|
| eTPU | mass | Average | area/average |
| pellets | [mg] | Length | volume |
| Example 1 | 4 | 3.8 | 2.1 |
| Example 2 | 4 | 3.8 | 2.0 |
| Comp. exa. 1 | 32 | 8.0 | 1.1 |
| Comp. exa. 2 | 32 | 7.7 | 1.2 |

The foamed pellets (Examples 1 and 2 and comparative example 1 and 2) are molded on a steam chest molder type Boost Energy Foamer K68 from company Kurtz ersa GmbH to quadratic plates (example plates 1-2 and comparative example plates 1-2) with the dimension of 200*200*10 mm and 200*200*20 mm (dimensions could vary slightly due to shrinkage). Molding conditions are presented in table 6.
By comparing example plate 1 with comparative example plate 1 and example plate 2 with comparative example plate 2, which were all molded with the same steaming conditions, it can be shown that by decreasing the average surface area to average volume ratio for foamed beads made from the same TPU, higher tensile strength can be reached at comparable rebound and compression hardness. This enables to mold beads with lower average surface area to average volume ratio with less intensive steaming conditions, which allows to produce parts with higher compression hardness at comparable tensile strength and rebound (compare example plate 1 to 3) (table 7). Tensile strength, compression hardness and rebound are determined as explained in method example 3 to 5.

TABLE 6
Steaming conditions during steam chest molding (Besides
crack size and cooling time 10 and 20 mm test plates
are molded under the same conditions; * Cooling time
is set to the same values on static and movable side)

| | Example | Example | Comp. exp | Comp. exp |
|---|---|---|---|---|
| Molded plate | plate 1 | plate 2 | plate1 | plate2 |
| E-TPU | Example 1 | Example 2 | Comp. exp 1 | Comp. exp 2 |
| Crack size - | 10/20 | 10/20 | 10/20 | 10/20 |
| 10/20 mm | mm | mm | mm | mm |
| plate (mm) | | | | |
| Crack steam | — | — | — | — |
| static side | | | | |
| (bar) | | | | |
| Crack steam | — | — | — | — |
| static side (s) | | | | |
| Crack steam | — | — | — | — |
| movable side | | | | |
| (bar | | | | |
| Crack steam | — | — | — | — |
| movable side | | | | |
| (s) | | | | |
| Cross steam | 1.2 | 1.2 | 1.2 | 1.2 |
| static side | | | | |
| (bar) | | | | |
| Cross steam | 7 | 7 | 7 | 7 |
| static side (s) | | | | |
| Cross steam | 1.2 | 1.2 | 1.2 | 1.2 |
| movable side | | | | |
| (bar) | | | | |
| Cross steam | 5 | 5 | 5 | 5 |
| movable side | | | | |
| (s) | | | | |
| Autoclave | 1.3/1.45 | 1.3/1.45 | 1.3/1.45 | 1.3/1.45 |
| steam static/ | | | | |
| movable | | | | |
| side (bar) | | | | |
| Autoclave | 40 | 40 | 40 | 40 |
| steam (s) | | | | |
| Cooling time* - | 100/120 | 100/120 | 100/120 | 100/120 |
| 10/20 | | | | |
| mm plate | | | | |

TABLE 7
Density and mechanical properties of the molded parts
produced from the examples and comparative examples

| | | | | | Compresssion | Compresssion |
|---|---|---|---|---|---|---|
| | Density 10 | Density 20 | Tensile | | hardness | hardness |
| | mm plate | mm plate | strength | Rebound | (10%) | (50%) |
| Molded plates | (g/L) | (g/L) | (MPa) | (%) | (kPa) | (kPa) |
| Example | 257 | 262 | 1.56 | 60 | 73 | 423 |
| plate 1 | | | | | | |
| Example | 274 | 272 | 1.55 | 57 | 128 | 541 |
| plate 2 | | | | | | |
| Comp. exp | 267 | 267 | 1.25 | 62 | 74 | 434 |
| plate1 | | | | | | |
| Comp. exp | 284 | 284 | 1.36 | 59 | 103 | 558 |
| plate 2 | | | | | | |

### II. Method Examples

### 1. Method Example 1: Average Particle Diameter (Length) and Width

a. Free Particles
The average particle length (defined here as diameter) and width of the free particles are received from particle size distribution measured with PartAn3D form Company Microtrac MRB.
The PartAn 3D uses an image evaluation according to an ISO 13322-2 to determine shape and size parameters for particles. The schematic structure of the device is shown in Fehler! Verweisquelle konnte nicht gefunden werden.
The measurement sequence for one sample of particles is as follows. 1 L of beads (for example 1 corresponding to a number of around 5,000 particles) are filled into a funnel (1) mounted over a vibrating channel (2). When the measurement stars the funnel is moving upwards and the vibration channel regulates the conveyance of the particles towards the camera. The camera is entrapped in a box (3) which has hole on the top. After reaching the end of the vibration channel the beads fall into the hole. On their way to the bottom the particles fell through the camera's field of view and several pictures are taken. As the particles rotate on their way down, pictures from different orientations are taken, what provides 3D information. Vibration channel and funnel movement are regulated so that the image area is obscured to 0.8% by the shadow of the particles falling from above (Further settings are listed in table 8). The camera is a 5 MP high-speed camera that captures at about 120 fps. Thus, an average of 8 images can be picked up from one falling particle. The corresponding evaluation software maps the individual images to each other and thus determines a data set for a measured particle from several images.
The size parameters for one particle are determined as an image analysis of all available images of this specific particle. Length and width are determined by applying parallel tangents to the outer edge of the particle on the respective image. The Length is defined as the largest, the width as the shortest possible distance between two parallel tangents (Fehler! Verweisquelle konnte nicht gefunden werden.). To receive one value for length, width and thickness for one particle the parameter Flength, Fwidth and FThickness are taken from the software. They are defined as follows: Flength: Largest value of all length values determined from all single pictures for the specific bead; Fwidth Largest value of all width values determined from all single pictures for the specific bead; FThickness: Smallest value of all width values determined from all single pictures for the specific bead. To get average values for one sample of particles the median of all Flength, Fwidth and FThickness values are taken.

TABLE 5
PartAn 3D settings for measuring the
particle size distribution of E-TPU

| Parameter | Unit | |
|---|---|---|
| Dosing control | | |
| Start | | |
| Startup area | % | 0 |
| Startup timeout | s | 300 |
| Stop measurement | — | |
| Area | | 0.03 |
| Vibration control | | |
| Gain | — | 444 |
| Time | — | 422 |
| Delay | — | 0 |
| Max | — | 25 |
| Min | — | 10 |
| Threshold level | % | 25.9 |

b. Particles in the Molded Body:
The average particle length (defined here as diameter) and width of the foamed pellets in the molded body are received from particle size distribution measured with computer tomocraphy (CT-scan) using standard parameters.
The average diameter is determined by measurement of at least 20 different particles in the cross section of a molded part in two perpendicular directions.

### 2. Method Example 2: Average Particle Surface and Volume

Average particle surface and volume are calculated by assuming that the particles are spheroids (ellipsoids with two equal semi-diameters (Fehler! Verweisquelle konnte nicht gefunden werden.). For calculation equation 1 and 2 were used. Based on this, the volume V and the surface A are calculated according to equation 1 and 2.

$$A \approx 4 {{n}^{*} ( ( {( {a}^{*} b )}^{1.6075} + {( {a}^{*} c )}^{1.6075} + {( {b}^{*} c )}^{1.6075} ) / 3 )}^{1 / 1.6075} \qquad ( 1 )$$

$$V = 4 / {4}^{*} {n}^{*} {a}^{*} {b}^{*} c \qquad ( 2 )$$

$$n = Π = 3.141592653589793$$

with a=Flength and b=c=FThickness
In the context of the present invention, the ratio of the average surface area to the average volume of the pellets (A/V) determined according to method-example 1 and 2 in a range of from 1.4 to 3.0 based on the absolute values of the average surface area to the average volume of the pellets unless noted otherwise.
Unless otherwise noted, a, b, and c are determined in mm in the context of the present invention and the volume V and the surface A are calculated on the respective values unless noted otherwise in the context of the present invention.

### 3. Method Example 3: Tensile Strength

Tensile strength and elongation at break are measured with a universal testing machine, which is equipped with a 2.5 kN force sensor (class 0.5 (ab 10N), DIN EN ISO 7500-1, 2018), a long-stroke-extensometer (class 1 after DIN EN ISO 9513, 2013) and pneumatic clamps (6 bar, clamping jaws out of pyramid grid (Zwick T600 R)).
The specimens (150 mm×25.4 mm×thickness of the test plate) are culled from a 200×200×10 mm test plate (dimensions could vary slightly due to shrinkage) with a cutting die. Before, the test plates were stored for at least 16 h under standardized climate conditions (23±2° C. and 50±5% humidity). The measurement is also carried out in standard climate. For each specimen density is determined. Therefore, mass (precision scale; accuracy: ±0,001 g) and thickness (caliper; accuracy: ±0.01 mm, contact pressure 100 Pa, value is only measured once in the middle of the specimen) are measured. Length (150 mm) and width (25.4 mm) are known from the dimension of the cutting die.
The L_{E}-position (75 mm) and the distance of the long-stroke-extensometer d (50 mm) are checked before stating the measurement. The specimen is placed on the upper clamp and the force is tared. Then the specimen is clamped and measurement could be started. The measurement is carried out with a testing speed of 100 mm/min and a force of 1 N. The calculation of tensile strength αₘₐₓ (specified in MPa) is done by equation (3), which is the maximum tension. This tension can be identical to the tension at breakage. Elongation at break (specified in %) is calculated using equation (4). Three specimens are tested for each material. The mean value from the three measurements is given. If the test specimen tears outside the selected area, this is noted. A repetition with another test specimen is not performed

$${σ}_{max} = \frac{{F}_{max}}{d \cdot b} \qquad ( 3 )$$

Fₘₐₓ=Maximum tention [N]
d=Thickness of the specimen [mm]
b=Width of the specimen [mm]

$$ε = \frac{{L}_{B} - {L}_{0}}{{L}_{0}} \cdot 100 \% \qquad ( 4 )$$

L_{B}=Length at breakage [mm]
L₀=Length before starting measurement [mm]

### 4. Method Example 4: Compression Hardness

For determination of the compression behaviour of the molded plates three specimens with the dimensions 50 mm*50 mm*original thickness of the plate (in general 20 mm but thickness can vary slightly due to shrinkage, skin is not removed) are taken from the plate by a band saw.
For each specimen the mass (precision scale; accuracy: ±0.001 g) and the length and thickness (calliper; accuracy: ±0.01 mm, contact pressure 100 Pa, value is only measured once in the middle of the specimen) are measured.
Compression behaviour is then measured with a 50 kN force transducer (class 1 according to DIN EN ISO 7500-1:2018-06), a crosshead travel encoder (class 1 according to DIN EN ISO 9513:2013) and two parallel pressure plates (Diameter 2000 mm, max. permissible force 250 kN, max. permissible surface pressure 300 N/mm 2) without holes. For determining the density of the specimen, the measured mass, length and thickness values are entered into the test specifications of the software of the test machine from company Zwick. The thickness of the specimen is determined by the universal test machine via the traverse path measuring system (accuracy: ±0.25 mm). The measurement itself is carried out with a test speed of 50 mm/min and a pre-force of 1 N. The force in kPa is recorded at a stint of 10 and 50 and. The values of the 1st cycle are used for evaluation. The sample during the measurement is compressed to 76%.
Measurement is conducted from 3 specimens taken from one plate. As result the average from all three measurements is taken.

### 5. Method Example 5: Rebound

Within the context of the present invention, unless otherwise stated, the rebound is determined analogously to DIN 53512, April 2000; the deviation from the standard is the test specimen height which should be 12 mm, but in this test 20 mm is used in order to avoid “penetration through” the sample and measurement of the substrate.

### CITED LITERATURE

Ullmann's “Encyclopedia of Technical Chemistry”, 4th edition, volume 20, p. 416 ff
WO 94/20568A1
WO 2007/082838 A1
WO2017/030835 A1
WO 2013/153190 A1
WO2010/010010 A1
WO 2019/185687 A1
WO2017/039451 A1
WO2018/004344 A1
Plastics Additives Handbook, 5th edn., H. Zweifel, ed., Hanser Publishers, Munich, 2001 ([1]), pp. 98-136
Kunststoff-Handbuch Band 4, “Polystyrol” [Plastics handbook, vol. 4, “Polystyrene”], by Becker/Braun (1996)

1-20. (canceled)

21: A molded body, comprising:
foamed pellets comprising a composition (M1) comprising a thermoplastic elastomer (TPE-1) having a ratio of an average surface area to an average volume of the foamed pellets (A/V) in a range of from 1.4 to 3.0,
wherein the volume V and the surface A are calculated according to equation 1 and 2:
$$A \approx 4 {{n}^{*} ( ( {( {a}^{*} b )}^{1.6075} + {( {a}^{*} c )}^{1.6075} + {( {b}^{*} c )}^{1.6075} ) / 3 )}^{1 / 1.6075} , \qquad ( 1 )$$
$$V = 4 / {4}^{*} {n}^{*} {a}^{*} {b}^{*} c , \qquad ( 2 )$$
wherein
n=π=3.141592653589793,
with a=Flength and b=c=FThickness,
wherein a, b, and c are determined in mm.

22: The molded body according to claim 21, wherein an average length of the foamed pellets is in a range of from 1 to 8 mm.

23: The molded body according to claim 21, wherein a ratio of an average length of the foamed pellets to an average width of the foamed pellets is in a range of from 1.0 to 2.0.

24: The molded body according to claim 21, wherein the thermoplastic elastomer (TPE-1) has a soft phase with a glass transition temperature T_{g} of <10° C. determined by dynamic mechanical thermal analysis determined by loss factor (tan δ) according to DIN EN ISO 6721-2011-08 at a heating rate of 2 K/min at a frequency of 1 Hz.

25: The molded body according to claim 21, wherein the composition (M1) has a G′ modulus of a compact material at room temperature in a range of from 10 to 90 MPa, determined using DMA of a tempered body (20 h/100° C.) according to DIN EN ISO 6721-1-7:2018-03 with a heating program of 2 K/min at a frequency of 1 Hz.

26: The molded body according to claim 21, wherein the thermoplastic elastomer (TPE-1) is selected from the group consisting of thermoplastic polyurethane, thermoplastic polyamide, thermoplastic polyetherester, thermoplastic polyesterester, thermoplastic vulcanizate, thermoplastic polyolefin, thermoplastic styrenic elastomer, and a mixture thereof.

27: The molded body according to claim 21, wherein the composition (M1) comprises a filler in an amount in a range of from 0.1 to 20 wt.-%, based on a weight of the composition (M1).

28: The molded body according to claim 21, wherein the molded body consists of the foamed pellets.

29: A process for preparing a molded body, comprising:
(i) providing foamed pellets comprising a composition (M1) comprising a thermoplastic elastomer (TPE-1) having a ratio of an average surface area to an average volume of the foamed pellets (A/V) in a range of from 1.4 to 3.0, and
(ii) fusing the foamed pellets to obtain the molded body,
wherein the volume V and the surface A are calculated according to equation 1 and 2:
$$A \approx 4 {{n}^{*} ( ( {( {a}^{*} b )}^{1.6075} + {( {a}^{*} c )}^{1.6075} + {( {b}^{*} c )}^{1.6075} ) / 3 )}^{1 / 1.6075} , \qquad ( 1 )$$
$$V = 4 / {4}^{*} {n}^{*} {a}^{*} {b}^{*} c , \qquad ( 2 )$$
wherein
n=π=3.141592653589793,
with a=Flength and b=c=FThickness,
wherein a, b, and c are determined in mm.

30: The process according to claim 29, wherein an average length of the foamed pellets is in a range of from 1 to 8 mm.

31: The process according to claim 29, wherein a ratio of an average length of the foamed pellets to an average width of the foamed pellets is in a range of from 1.0 to 2.0.

32: The process according to claim 29, wherein the thermoplastic elastomer (TPE-1) has a soft phase with a glass transition temperature T_{g} of <10° C., determined by dynamic mechanical thermal analysis determined by loss factor (tan δ) according to DIN EN ISO 6721-2011-08 at a heating rate of 2 K/min at a frequency of 1 Hz.

33: The process according to claim 29, wherein the composition (M1) has a G′ modulus of a compact material at room temperature in a range of from 10 to 90 MPa, determined using DMA of a tempered body (20 h/100° C.) according to DIN EN ISO 6721-1-7:2018-03 with a heating program of 2 K/min at a frequency of 1 Hz.

34: The process according to claim 29, wherein the thermoplastic elastomer (TPE-1) is selected from the group consisting of thermoplastic polyurethane, thermoplastic polyamide, thermoplastic polyetherester, thermoplastic polyesterester, thermoplastic vulcanizate, thermoplastic polyolefin, thermoplastic styrenic elastomer, and a mixture thereof.

35: The process according to claim 34, wherein the thermoplastic elastomer (TPE-1) is selected from the group consisting of thermoplastic polyurethane, thermoplastic polyamide, thermoplastic polyetherester, thermoplastic polyesterester, and a mixture thereof.

36: The process according to claim 35, wherein the thermoplastic elastomer (TPE-1) is a thermoplastic polyurethane.

37: The process according to claim 29, wherein the composition (M1) comprises a filler in an amount in a range of from 0.1 to 20 wt.-%, based on a weight of the composition (M1).

38: The process according to claim 29, wherein (ii) is carried out by thermal fusing.

39: A molded body, obtained or obtainable by the process according to claim 29.

40: An article, comprising the molded body according to claim 39,
wherein the article is selected from the group consisting of furniture, seating, cushioning, a car wheel, a part of a car wheel, a toy, an animal toy, a tire, a part of a tire, a saddle, a ball, sports equipment, a floor covering, and wall paneling.
